(19) United States
(12) Patent Application Publication
(10) Pub. No.: US 2008/0006212 A1
(43) Pub. Date: Jan. 10, 2008

(54) TRANSPORTABLE AID FOR FEEDING AN ANIMAL

(76) Inventor: Michael Adrian Ebert, St. Marys (CA)

Correspondence Address: Michael Ebert, RR3, 17563 Gregory Dr., St. Marys, N4X 1C6, omitted

(21) Appl. No.: 11/456,272

(22) Filed: Jul. 10, 2006

(51) Int. Cl. A01K 7/00

(52) U.S. Cl. 119/72

(57) ABSTRACT

The Aid comprises a combination of a pail and a tray. The pail is a conventional plastic-moulded pail, having a hinged handle. The tray is a one-piece plastic moulding, having a platform whereby the tray rests on the top rim of the pail, and having a skirt for holding the tray in position laterally with respect to the pail. The tray includes two feeding bowls. The pail serves as a container for supplies etc, as needed during transport of the animal.

This invention relates to apparatus for use when transporting a pet dog or other animal, the apparatus being structured for carrying food and other supplies, and for presenting the food to the dog for eating.

### BACKGROUND TO THE INVENTION

It is an aim of the invention to provide such apparatus in a form that combines neatness and attractiveness of appearance with simplicity and convenience in operation and use. It is also an aim that the apparatus be sturdy, yet inexpensive to manufacture.

It is well-known that a dog is more comfortable, when feeding, if the food can be placed, not at ground level, but at an elevated or raised level above the ground, whereby the dog does not need to lower its head in order to reach the food. The apparatus described herein is aimed also at accommodating this aspect.

### THE PRIOR ART

Patent publication U.S. Pat. No. 6,145,474 (Lemkin, November 2000) may be considered relevant to the apparatuses described herein.

### DETAILED DESCRIPTION OF PREFERRED EMBODIMENTS

By way of further explanation, exemplary apparatuses will now be described with reference to the accompanying drawings, in which:

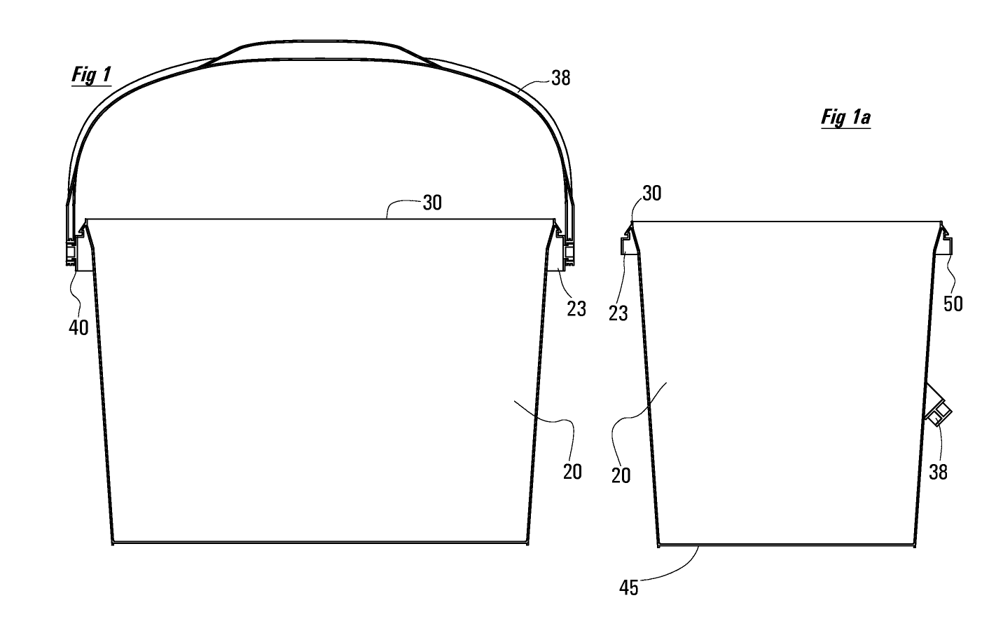

FIG. 1 is a cross-sectioned front elevation of a pail.

FIG. 1a is a cross-sectioned side elevation of the pail of FIG. 1.

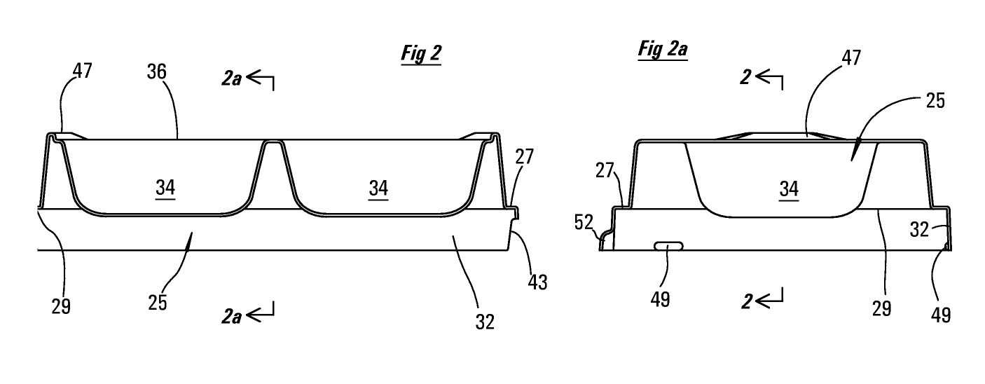

FIG. 2 is a cross-sectioned front elevation of a dog feeding tray, for use in association with the pail of FIG. 1.

FIG. 2a is a cross-sectioned side elevation of the tray of FIG. 2.

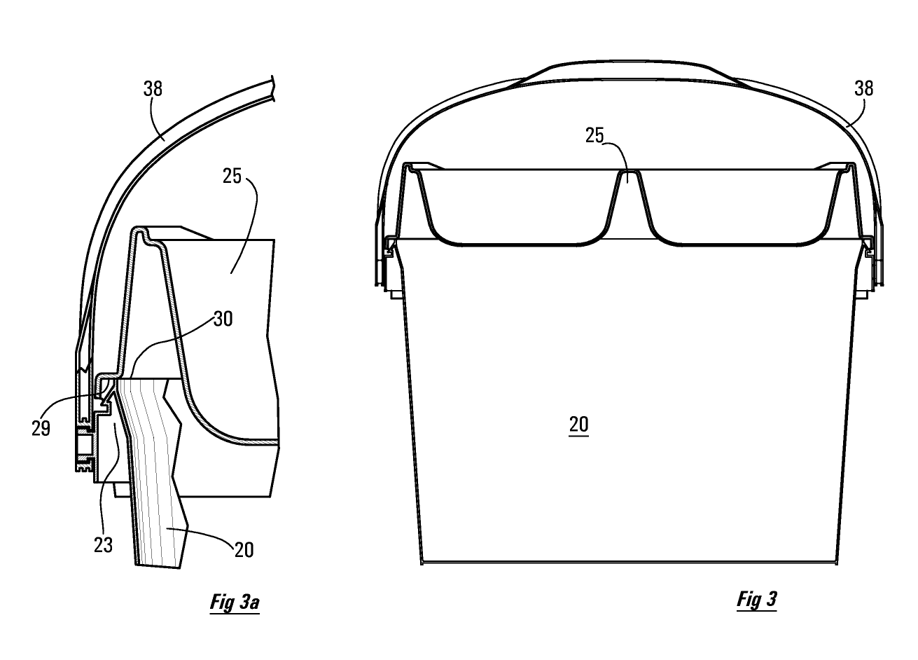

FIG. 3 is the same elevation as FIGS. 1,2, showing the tray assembled to the pail.

FIG. 3a is a close-up of the left side of FIG. 3.

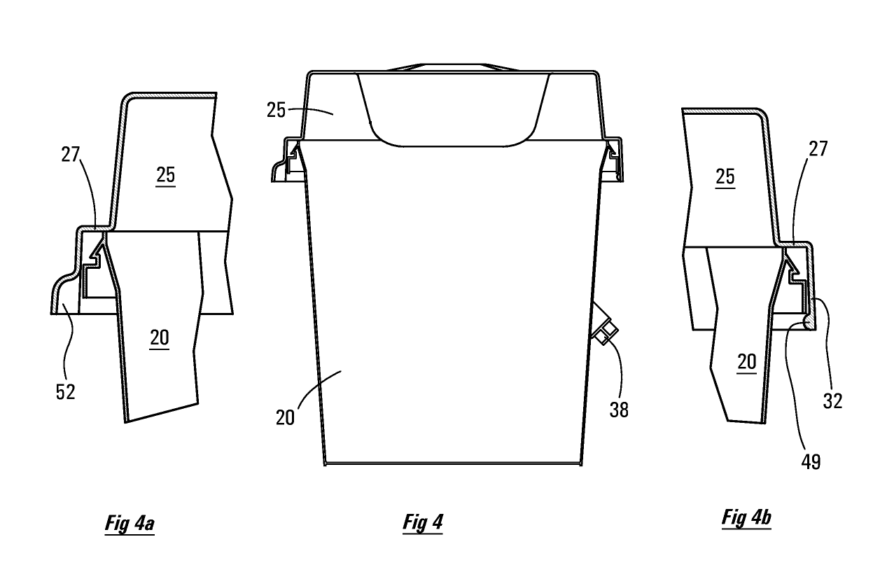

FIG. 4 is the same elevation as FIGS. 1a,2a, showing the tray assembled to the pail.

FIG. 4a is a close-up of the left side of FIG. 4.

FIG. 4b is a close-up of the right side of FIG. 4.

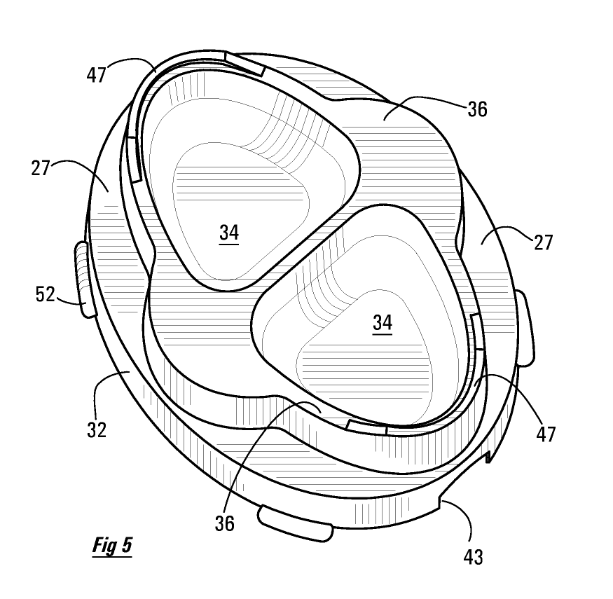

FIG. 5 is a pictorial view of the tray of FIG. 2.

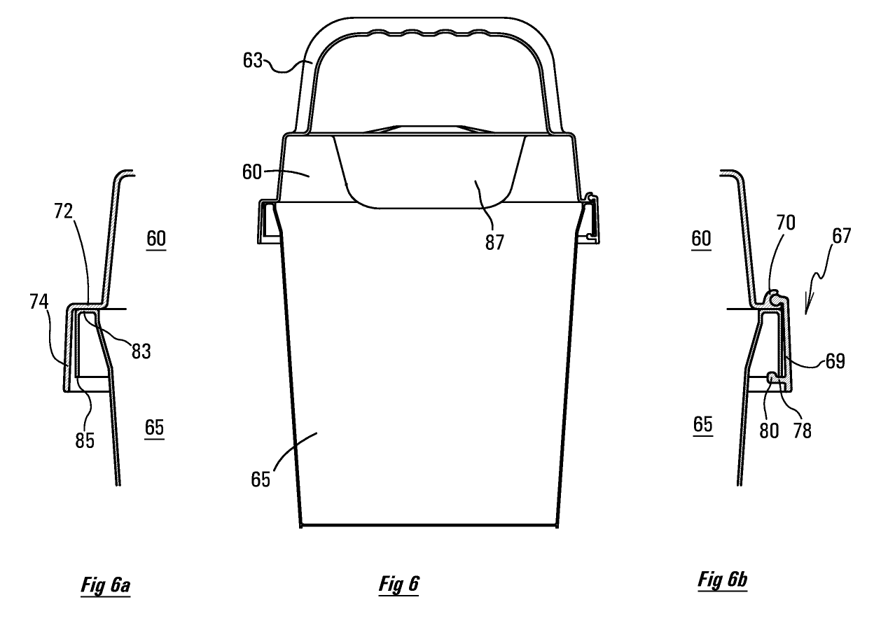

FIG. 6 is a similar elevation to FIG. 4, showing a different tray.

FIG. 6a is a close-up of the left side of FIG. 6.

FIG. 6b is a close-up of the right side of FIG. 6.

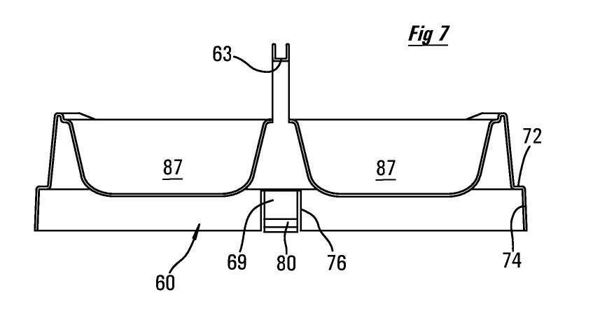

FIG. 7 is a similar elevation to FIG. 2, showing the tray of FIG. 6.

The apparatuses shown in the accompanying drawings and described below are examples. It should be noted that the scope of the patent protection claimed is defined by the accompanying claims, and not necessarily by specific features of exemplary apparatuses.

FIGS. 1,1a show a bucket or pail 20. In plan view, the pail is oval or elliptical. In the particular example, the pail has a major-diameter of 380 mm, a minor-diameter of 299 mm, and a height of 276 mm. The pail is an injection moulding in polypropylene. The pail 20 itself is of a conventional type, and has a moulded rim 23.

FIGS. 2,2a,5 show a dog feeding tray 25. The tray 25 is an injection moulding, preferably in polypropylene, although other plastics may be used. The tray 25 is shaped and dimensioned to fit over the rim 23 of the pail 20. The tray 25 has a platform 27, a downwards-facing under-surface 29 of which makes touching contact, as shown in FIGS. 3,3a,4,4a,4b, with the upwards-facing over-surface 30 of the rim 23 of the pail, when the tray is resting on the rim. The tray 25 simply rests on the rim 23, and the tray can be removed simply by lifting it away.

A skirt 32 around the base of the tray 25 locates the tray, when placed on the pail, in position, and holds the tray constrained against being knocked aside (laterally), and falling off the pail 20.

The moulded tray 25 is formed with two bowls 34. The bowls 34 are in the form of depressions formed down into the top surface 36 of the tray. As shown, the two bowls 34 are the same; alternatively, the bowls may be different from each other. Alternatively also, the bowls may be one, or three or more, in number.

In use, when transporting a dog on a trip, the (human) owner prepares supplies (food, water, toys, leash, etc) and places the bags, cans, bottles, and other things inside the pail 20. When the supplies are all in place, the owner places the tray 25 on top of the pail.

The rim 23 of the pail is configured to accept a sealing-lid (not shown) having a complementary sealing flange. It may be arranged that the user can apply this sealing-lid to the pail 20 prior to placing the tray 25 on top of the pail. The designer should of course see to it, in this case, that the form of the tray 25 accommodates the form of the sealing-lid. Preferably, the chosen design of the pail should be such that the rim 23 of the pail is ready to receive the tray, with or without the sealing-lid. The sealing-lid, if used, can provide a freshness seal, the presence of which can be advantageous when carrying perishable foods.

It would not be preferred to arrange for the tray 25 itself to seal onto the rim 23 of the pail 20, rather than the sealing-lid. A purpose-designed sealing lid can be arranged to be easy to remove, because such a sealing-lid can be arranged to be flexible; however, if the tray 25 were designed to be flexible, as it would have to be to provide the sealing function, the main function of the tray as a dog feeding tray might then be unduly compromised.

To prepare for a meal, the owner lifts the tray 25 off the pail 20—and removes the sealing-lid, if present—thereby gaining access to the contents of the pail. Then, they transfer the food, water, etc into the bowls 34 provided in the tray. The intention is that the owner will then place the tray back on the pail, and the dog will feed from the tray while the tray is thus raised off the ground. Alternatively, the owner might place the tray on the ground, and the dog can feed from that.

The pail 20 also includes a carrying handle 38, which is hinged to the rim 23 of the pail at 40. Other designs of handle can be acceptable, but the pail should preferably be of the type in which the handle 38 moves out of the way, preferably by being pivoted, as shown, whereby the user then has easy access for putting the tray 25 onto the pail and taking it off, and whereby, with the handle 38 pivoted out of the way, the dog has free access for feeding.

The handle 38 serves as the means by which the combination of pail and tray can be picked up and carried. It is preferred that the handle for the combination should be included in the pail 20, rather than included in the tray 25, as it would be difficult to provide an adequate handle as a component of the tray 25. Of course, traditional conventional pails already do come with a perfectly serviceable, tried-and-tested, handle, and the designer should choose a pail with such a handle, for use in the combination. While it would be simple enough to provide e.g moulded finger-grips into the form of the pail, it would be difficult to provide such a form of handle that would permit the combination to be upright during carrying—i.e when the combination is being carried with one hand—but that difficulty disappears when the pail has a conventional hinged pail-handle. The designer should, of course, see to it that the hinged handle is free to pivot when the tray is in place, and in the present example the cut-out 43 in the skirt 32 of the tray 25 is included to ensure that the handle can swing freely.

It is not ruled out that the combination of pail and tray might be in continual usage—e.g if the combination is used for transporting a dog regularly to dogshows and the like. But in many cases, the described combination of pail and tray would have only occasional usage, e.g it would be used for occasional trips or visits of a pet dog away from home. In that case, during periods of non-use of the combination, the pail, being a regular pail, can be used as such. Thus, the pail and the tray might well be stored separately, in a typical household, during periods of non-use. That being so, it is advantageous that no fasteners or other small parts are needed to make the combination operable, as such small parts might very easily become detached and lost. Of course, nothing can be guaranteed to be unloseable, but the feeding tray 25 is considered to be a large enough item, in itself, that most households would be able to locate it when needed, even though the tray had become separated from the pail. For this reason, it is preferred that the tray should be moulded as a single piece of plastic, but it is not ruled out that, for example, the bowls could be formed as separate pieces, detachable from a tray base.

Preferably, the designer should design the tray from the standpoint of stackability. Thus, the trays themselves should be stackable—but that is simple to arrange when the tray is moulded as a one-piece tray, as shown. Also, the pails should be stackable—but again, conventional plastic-moulded pails are usually stackable. The designer should also prefer to make the combination stackable; that is to say, the overall design of the combination should be such that when a second combination is placed on top of a first combination that is already resting on a surface, the second combination is supported firmly and strongly by the first combination underneath. Thus, the top surface 36 of the tray 25 should be designed to fit the undersurface 45 of the bottom of the pail 20. It is contemplated that several assembled combinations might be stacked one on top of another. This can arise when the combinations are being sold with a selection of proprietary dog food items contained in the pail—for example, as an aid to promotional marketing of the items. In that case, the assembled combination can be quite heavy, and the pail and tray must be robust enough, in combination, to support the weight of several laden combinations resting thereon.

The top surface 36 of the tray 25 is provided with protruding ridges 47, which receive the (oval) form of the bottom 45 of the pail 20 of the combination above, and thereby aid in keeping the stack straight.

As mentioned, the tray 25 includes a skirt 32. The form of the skirt is such that the skirt can be distorted (slightly) inwards at one diameter while distorting outwards at another diameter, and the skirt 32 is also somewhat springy in the sense that the skirt will naturally spring back to its as-moulded form after being so distorted. This springiness of the skirt can be made use of, in that locking tabs 49 can be provided on the inside surface of the skirt 32. The rim 23 of the pail 20 is inverted, and includes a downward-facing surface 50 of the rim, and the locking tabs 49 are arranged to engage underneath the surface 50. When the tray is lowered down onto the pail, the skirt bends outwards, at the locations of the tabs 49, as the tabs ride over the form of the rim, until the tabs snap underneath the surface 50. To release the tray from the pail, a person pulls the skirt outwards, until the tabs come clear.

It will be understood that the purpose of the engagement of the tabs 49 is to ensure that the tray does not tend to become unattached from the pail 20 during transport and storage. It might be considered that the engagement of the tabs 49 with the under-surface 50 of the rim 23 might be secure enough to permit the whole combination to be picked up via the tray. However, if the combination were designed that way, the weight of the pail (and contents) would be transmitted through the tabs engagement, and it is recognised that it would be difficult for the designer to provide the needed robustness and security in an engagement arranged that way. Therefore, preferably the combination of pail, pail contents, and tray, as a whole assembly, should be picked up and carried by means of a handle that is firmly attached to the pail.

To aid in pulling the skirt 32 outwards (to release the tray from the pail), and in handling the tray generally, the skirt may be provided with moulded-in finger-holds 52.

As mentioned, the downwards-facing under-surface 29 of the platform 27 rests on the upwards-facing over-surface 30 of the rim 23, when the tray 25 is resting on the pail 20. The platform 27 is moulded into the tray, and its main purpose is to furnish and provide the under-surface 29, whereby the tray takes support from the pail. In most conventional pails, the over-surface 30 of the rim of the pail extends uninterruptedly in a horizontal plane around the whole circumference of the pail; however, the under-surface 29 of the tray platform, on the other hand, need not be present over the whole extent of the over-surface 30 of the pail 20. The contact between the platform 27 and the rim 23 should be extensive enough that the tray does not tend to twist or otherwise distort under e.g the weight of a stack of loaded combinations above.

The designer of the animal-feeder combination as described herein preferably should start off with a proprietary design of pail. It is preferred to design the dog feeding tray to fit a pre-existing pail than to design the tray first and then design a pail to suit the tray. Selecting a pre-existing design of pail is advantageous because mass-produced moulded-plastic pails are readily available and inexpensive, compared with the outlay needed to produce a newly moulded component. Thus, the pail as used in the combination should be selected from the large number of readily available proprietary designs of plastic pail—being designs that have already been fully engineered and tested. The designer of the combination preferably does not design the pail, as such; rather, the designer selects a particular pre-existing design of pail, and then designs the tray to suit.

It is suggested that the combination as described herein be marketed in a range of sizes. Thus, the designer should select, for instance, three sizes of pre-existing pail: small, medium, large, which may be dimensioned—as to major-diameter, minor-diameter, depth of pail (in millimetres)—as (small) 239, 179, 141 and (medium) 308, 238, 193 in addition to the (large) 380; 299; 276 size mentioned above.

It will be noted that, for a larger dog, everything about the combination needs to be larger. Thus, the feeding bowls, the storage capacity inside the pail, the height of the bowls off the ground, and so on, should all be larger. Thus, it does not matter that the combination as described herein does not lend itself to a one-size-fits-all approach. Also, the combination need not be adjustable as to size.

The pail preferably is oval (elliptical) as to its plan-profile. Other configurations may be used, such as circular, rectangular (with or without rounded-corners), etc. The tray can then be designed to suit the plan-profile of the selected pail. Preferably, the form of the under-surface 29 of the platform 27 of the tray is arranged symmetrically, whereby the tray can be assembled onto the pail, oriented as to coincidence of the major-diameters of the tray and the pail, but not limited as to which way round the tray fits on the pail.

Dogs can be boisterous, and there might be a tendency for the combination to tip over, during use, if the combination is too tall for its base. Thus, the ratio of the height of the top surface 36 of the tray to the minor-diameter of the plan-profile of the pail preferably should be no more than 1½:1.

The pail as described herein is of plastic. The pail could be of metal; however, the requirement for the pail may be characterised as “light duty”, for which plastic is very suitable, and is preferred for lightness and ease of use.

In FIGS. 6,6a,6b,7, the tray 60 is similar to the tray 25 of the previous drawings, except that now the tray 60 includes a moulded-in handle 63. In FIGS. 6,6a,6b,7 (as in the previous versions) the combination can be picked up and carried using just one hand. During carrying, the tray 60, together with the pail 65, remain in an upright condition—as was the case in the previous drawings.

But now, in FIGS. 6,6a,6b,7, the handle 63 is a component of the tray 60, not of the pail 65. Therefore, the weight of the pail 65 (and the weight of the contents, if any, of the pail) is transmitted to the handle 63, not by the structure of the pail 65 itself, but through attachment assemblies 67, by which the tray 60 is secured to the pail 65. These attachment assemblies 67 must therefore be much more secure than was the case with the tabs 49 as shown previously.

One of the attachment assemblies 67 is shown in FIG. 6b. The assembly includes a hinged clip 69, and includes a hinge-boss 70 moulded into the platform 72 of the tray 60. The skirt 74 of the tray 60 is cut away to form a window 76 (FIG. 7), to create room for the clip 69 to swing.

To release the attachment assembly, the clip 69 is pivoted upwards and aside, which can be done by manipulation with the fingers.

In profile, the clip 69 includes a stalk 78, which carries a knob 80 on the left end thereof. The stalk 78 can be deflected downwards, and the down-turned rim 83 of the pail 65 can be deflected upwards a little, by the finger manipulation, whereby the knob 80 can be manoeuvred underneath the downwards-facing underface 85 at the bottom of the rim 83. Then, the clip 69 can be moved aside, and the tray 60 can be lifted off the pail 65.

The attachment assemblies 67 are located around the circumference of the skirt 74 of the tray in sufficient number (e.g four) to ensure security.

In the full-clipped condition illustrated in FIG. 6b, the attachment assembly 67 is firmly closed, and the pail 65 cannot accidentally release itself from the tray 60. It should be noted that, in the previous drawings, where the handle 38 was on the pail 20, the security with which the pail and tray needed to be constrained against accidental separation could be much less—whereby the tabs 49 were perfectly adequate. But, when the handle 63 is on the tray 60, the tabs 49 would not be secure enough to be relied on.

When the handle is on the tray, preferably the handle should not obstruct the dog's access to the feeding bowls. Preferably, the tray 60 includes two such bowls 87, and the handle 63 is located between the two bowls, as shown. Now, the dog can feed from either of the bowls 87, and not be impeded by the handle.

Whether the handle is on the pail (as in FIG. 1) or on the tray (as in FIG. 6) the handle should be so arranged as to lie above the centre of gravity of the combination of tray-plus-pail. When that is so arranged, and when the handle is held in just one hand, the weight of the combination can be carried, and the combination can remain upright, basically without the need for the person to exert muscular effort. But if the handle were off-centre, the user then would need to exert muscular effort with the hands and wrists in order to support the weight and to keep the combination upright. Thus, an off-centre handle might be adequate if the item being supported were light in weight or were only being supported for a moment. But an off-centre handle soon becomes quite irritating if the item is heavy, or has to be carried a substantial distance.

An off-centre handle, in this sense, is a handle the centre of which lies more than about an inch from the central axis of the combination, i.e the vertical line that passes through the centre of gravity of the combination. The preference is that the centre of the handle lies actually on the central axis.

If handles were to be arranged off-centre—in order to permit access to a single feeding bowl, for example—generally two handles would be needed, whereby the person would need to use both hands to pick up and carry the combination.

1. Combination of a pet feeding tray and a bucket or pail, together with a carrying handle, wherein:
[2] the combination includes an engagement means, by means of which the tray engages with the pail, and which is so structured that the combination is physically unitary, in that the combination can be picked up and carried, as a unit, by a person, using only one hand;
[3] when the pail is upright, and resting on a horizontal surface, a central axis of the combination is a vertical line passing through the centre of gravity of the combination;
[4] the carrying handle is so arranged in the combination that, when the combination is being carried by a person holding the handle in one hand, the handle and that one hand lie substantially on the said central axis, above the centre of gravity, whereby, when the combination is so carried, the pail remains in an upright condition;
[5] the tray is movable relative to the pail;
[6] the tray includes a top upwards-facing surface, and includes at least one bowl-shape, which is physically suitable for containing food or water for the pet;
[7] the pail includes, at or near the top thereof, a rim, which includes an upwards-facing over-surface;
[8] the tray is formed with a platform, and the tray is so configured that, when the tray is assembled to the pail, a downwards-facing under-surface of the platform rests in contact with the over-surface of the rim of the pail.

2. Combination of claim 1, wherein the pail has a hollow interior defined by side walls, having inwards-facing surfaces that are smooth and substantially free of protrusions that protrude into the hollow interior.

3. Combination of claim 1, wherein:
[2] the engagement means includes a skirt of the tray;
[3] the platform lies intermediately between the top surface of the tray and the skirt;
[4] the skirt surrounds the platform;
[5] the skirt extends downwards from the platform;
[6] the skirt extends down to, and forms a skirt-base at, a bottom-most extremity of the tray;
[7] the skirt-base is flat and planar;

4. Combination of claim 3, wherein:
[2] when the pail is upright, the upwards-facing oversurface of the rim of the pail lies in a flat horizontal plain, and is uninterrupted around the circumference of the pail;
[3] the under-surface of the platform of the tray lies in a single horizontal plane;
[4] the top rim of the pail has a plan-view profile, and the skirt has a plan-view profile;
[5] the plan-view profile of the platform of the tray corresponds in shape and size to the plan-view profile of the rim of the pail, to the extent that, when the tray is assembled to the pail, the skirt lies outside the rim of the pail, but fits closely enough to the rim that the skirt thereby locates the tray on the rim of the pail, and constrains the tray against lateral movement of the tray relative to the pail.

5. Combination of claim 1, wherein the tray is movable relative to the pail to the extent that a person can move the tray sufficiently to gain access to the interior of the pail.

6. Combination of claim 1, wherein the tray is movable relative to the pail in the sense that the tray can be completely separated physically apart from the pail.

7. Combination of claim 1, wherein the tray is a plastic-injection moulding, formed as one single piece.

8. Combination of claim 1, wherein the engagement means includes a lateral constraining structure, which:—
[2]—is a component of the tray;
[3]—is arranged for engagement with the rim of the pail; and
[4]—is effective, when the tray is assembled to the pail, to hold and constrain the tray in such manner as to prevent or limit movement of the tray laterally with respect to the pail.

9. Combination of claim 1, wherein the carrying handle is a component of the pail.

10. Combination of claim 9, wherein:
[2] the pail includes a handle pivot, which is so arranged that the carrying handle is hinged or pivoted with respect to the pail; and
[3] the combination is so arranged that the handle can be hinged or pivoted when the tray is in place resting on the rim of the pail.

11. Combination of claim 9, wherein:
[2] the pail includes, at or near the top thereof, an overturned lip, having a down-facing face;
[3] the tray includes a tab that protrudes inwards from the skirt, and which is so dimensioned as to snag underneath the down-facing face of the overturned lip; and
[4] the skirt is resilient enough to normally bias the tab underneath the down-facing face and yet to allow the skirt to distort sufficiently to enable the tab, by hand manipulation, to be pried clear of the down-facing surface, whereupon the tray can be removed from the pail.

12. Combination of claim 1, wherein the carrying handle is a component of the tray.

13. Combination of claim 12, wherein:
[2] the pail includes, at or near the top thereof, an overturned lip, having a down-facing face;
[3] the engagement means includes a clip assembly, including a clip which is movable between two positions, being an engaged position and a released condition;
[4] in the engaged position, an upwards-facing ledge of the clip engages underneath the downwards-facing undersurface of the rim of the pail;
[5] in the released position, the ledge lies clear of the rim of the pail;
[6] the clip is located in a window in the skirt of the tray; and
[7] the structure of the clip assembly is such that, when in the engaged position, the assembly is sufficiently strong and secure to support the weight of the pail, and of the contents of the pail, if any.

14. Combination of claim 1, wherein:
[2] the pail includes, at or near the top thereof, an overturned lip, having a down-facing face;
[3] the engagement means includes a clip assembly, including a clip which is movable between two positions, being an engaged position and a released condition;
[4] in the engaged position, an upwards-facing ledge of the clip engages underneath the downwards-facing undersurface of the rim of the pail;
[5] in the released position, the ledge lies clear of the rim of the pail;
[6] the clip is located in a window in the skirt of the tray; and
[7] the structure of the clip assembly is such that, when in the engaged position, the assembly is sufficiently strong and secure to support the weight of the pail, and of the contents of the pail, if any.

15. Procedure for providing many combinations of a pail and a pet feeding tray, including:
[2] selecting a pre-existing design of pail, being a design having the following characteristics:—
[3]—pails of the said pre-existing design are available on a mass-produced basis;
[4]—the pail is a plastic moulding;
[5]—the pail includes, at or near the top thereof, a rim comprising an upwards-facing over-surface;
[6]—the upwards-facing over-surface of the rim is planar and horizontal;
[7]—the pail has a hollow interior defined by side walls, having inwards-facing surfaces that are substantially smooth and even and are substantially free of protrusions that protrude into the hollow interior;
[8]—the pail includes a handle, whereby the pail can be picked up and carried, with the rim in a horizontal plane, with one hand;
[9] after selecting the said design of pail, then designing a tray to have the following characteristics:—
[10]—the tray is formed with a platform, and the tray is so configured that, when the tray is assembled to the pail, a downwards-facing under-surface of the platform rests in contact with the said over-surface of the rim of the pail;
[11]—the tray includes a lateral constraining structure, which is arranged for engagement with the rim of the pail, and is effective, when the tray is assembled to the pail, to hold and constrain the tray in such manner as to prevent or limit movement of the tray laterally with respect to the pail;
[12]—the tray includes a top upwards-facing surface, and includes at least one bowl-shaped depression, which extends down into the said top surface, and which is physically suitable for containing food or water for the pet;
[13]—the tray is physically removable and separable from the pail;
[14]—the pail includes a handle, which is so arranged in the pail that the assembled combination of the pail and tray together can be picked up and carried by the handle, with one hand;
[15] obtaining quantities of pails to the said pre-existing design;
[16] obtaining quantities of trays having the said characteristics by procuring a mould, and by moulding the trays therein.
